(19) United States
(12) Patent Application Publication
(10) Pub. No.: US 2025/0243906 A1
(43) Pub. Date: Jul. 31, 2025

(54) ELASTOMERIC BUSHING

(71) Applicant: The Pullman Company, Milan, OH (US)

(72) Inventors: Loren Dean PRIEBE, Sandusky, OH (US); Kurt J. Stoll, Milan, OH (US)

(21) Appl. No.: 18/422,835

(22) Filed: Jan. 25, 2024

(51) Int. Cl. F16C 33/20; F16C 17/02

(52) U.S. Cl. CPC F16C 33/203; F16C 17/02

(57) ABSTRACT

An elastomeric bushing comprises an elastomeric bumper disposed around and directly engaging an inner sleeve. An outer sleeve is disposed around the inner sleeve and the elastomeric bumper. The inner sleeve includes radially outwardly extending first and second flanges at opposite ends. The inner sleeve includes a centralized bulbous portion with first and second neck portions positioned on opposite sides of the bulbous portion. The inner sleeve further includes first through fourth surfaces extending between the neck portions and the flanges as well as between the neck portions and the bulbous portion. A first cushion portion of the elastomeric bumper is trapped between the first and third surfaces. A second cushion portion of the elastomeric bumper is trapped between the second and fourth surfaces.

### FIELD

The present disclosure relates to an elastomeric bushing for securing a component to a vehicle. The elastomeric bushing provides a reduced cost arrangement exhibiting robust product life.

### BACKGROUND

This section provides background information related to the present disclosure which is not necessarily prior art.

Elastomeric bushings have been implemented in a variety of applications including, but not limited to, independent suspension control arms, torsion bars, linear suspension rods, leaf springs, and other vehicular component interconnections. Any number of vehicles including automobiles, trucks, buses, off-highway vehicles, rail cars and the like may utilize elastomeric bushings.

An elastomeric bushing assembly typically includes an outer sleeve, an inner sleeve, and an elastomeric bushing radially disposed between the outer sleeve and the inner sleeve. The outer sleeve may be a tubular member formed as a portion of the suspension component or the outer sleeve may be a separate tubular member that is configured to be pressed into or otherwise attached to a vehicle suspension member.

The inner sleeve is typically constructed as a right circular hollow cylindrical member which is adapted to be secured to the vehicle or a suspension member. In another example, the inner sleeve is replaced by a solid cylindrical member such as a bar pin that includes a cylindrical center section and flattened ends extending outwardly from the cylindrical center section.

In another example, a known elastomeric bushing is provided for certain high load applications where the ends of the outer sleeve are curved or otherwise radially inwardly deformed to extend toward the inner sleeve. In this manner, the outer sleeve encapsulates and compresses the axial ends of the elastomeric material to increase the radial spring rate and the axial spring rate of the elastomeric bushing. The mechanical deformation process to curl over the ends of the outer sleeve is an additional step required beyond the standard molding process of a typical bushing. In some cases, the curling process deforms the outer sleeve to such an extent that another additional step in the production process is required to qualify a size and shape of an outer surface of the outer sleeve. In one arrangement, an additional grinding process is required to properly size and shape the outer surface of the outer sleeve.

Elastomeric bushings incorporating an outer sleeve having curled ends have satisfactorily performed in the past. A need in the art exists, however, to provide a bushing having improved dimensional control while eliminating the need for additional manufacturing process steps to axially confine the elastomeric material between the outer sleeve and the inner sleeve. It may be beneficial to provide an elastomeric bushing having a reduced cost of manufacture while providing target radial and axial deflection rates.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

An elastomeric bushing comprises an elastomeric bumper disposed around and directly engaging an inner sleeve. An outer sleeve is disposed around the inner sleeve and the elastomeric bumper. The inner sleeve includes radially outwardly extending first and second flanges at opposite ends. The inner sleeve includes a centralized bulbous portion with first and second neck portions positioned on opposite sides of the bulbous portion. The inner sleeve further includes first through fourth sloped surfaces extending between the neck portions and the flanges as well as between the neck portions and the bulbous portion. A first cushion portion of the elastomeric bumper is trapped between the first and third sloped surfaces. A second cushion portion of the elastomeric bumper is trapped between the second and fourth sloped surfaces.

In an alternate arrangement, an elastomeric bushing comprises an elastomeric bumper disposed around and directly engaging an inner sleeve. An outer sleeve is disposed around and directly engages the elastomeric bumper. The inner sleeve includes first and second neck portions positioned on opposite sides of a centralized bulbous portion. A radially outwardly extending first surface is positioned between the bulbous portion and the first neck portion. A radially outwardly extending second surface is positioned between the bulbous portion and the second neck portion. A radially outwardly extending third surface is positioned at the opposite end of the first neck portion as the first surface. A radially outwardly extending fourth surface is positioned at the opposite end of the second neck portion as the second surface. The first surface and the third surface trap a first cushion portion of the elastomeric bumper therebetween. The second surface and the fourth surface trap a second cushion portion of the elastomeric bumper therebetween.

### BRIEF DESCRIPTION OF THE DRAWINGS

The present disclosure will become more fully understood from the detailed description and the accompanying drawings, wherein:

FIG. 1 is a perspective view of an exemplary elastomeric bushing assembly with a bar pin positioned therein;

FIG. 2 is an exploded perspective view of the elastomeric bushing assembly and bar pin; and

FIG. 3 is a cross-sectional view taken along line 3-3 as shown in FIG. 1.

In the drawings, reference numbers may be reused to identify similar and/or identical elements.

### DETAILED DESCRIPTION

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Further areas of applicability of the present disclosure will become apparent from the detailed description, the claims and the drawings. The detailed description and specific examples are intended for purposes of illustration only and are not intended to limit the scope of the disclosure.

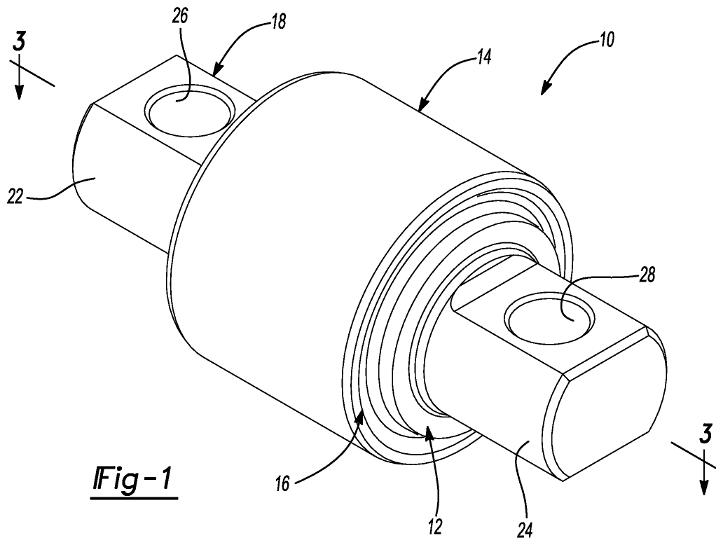

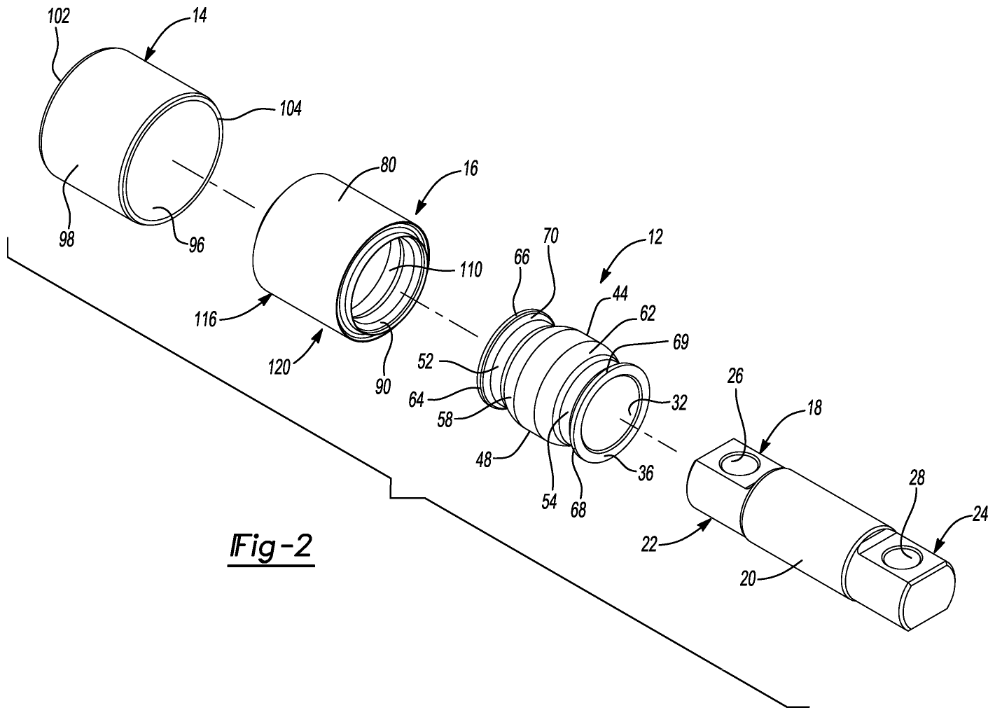

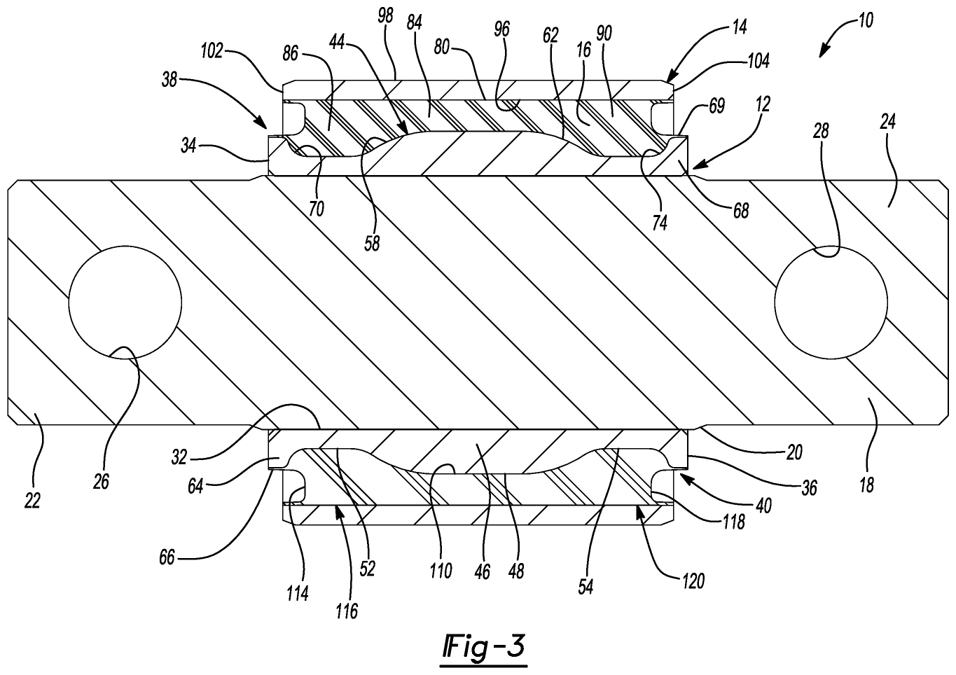

With reference to FIGS. 1-3, an elastomeric bushing assembly 10 includes an inner sleeve 12, an outer sleeve 14, and an elastomeric bumper 16 positioned radially therebetween. Elastomeric bushing assembly 10 is depicted as being in cooperation with an exemplary bar pin 18. As shown in FIG. 3, bar pin 18 includes an enlarged central cylindrical portion 20 shown in a press-fit interconnection with inner sleeve 12. It should be appreciated that this configuration is merely exemplary and provides a non-limiting example of a use for elastomeric bushing assembly 10. Bar pin 18 includes a first end 22 and an opposite second end 24. First end 22 and second end 24 are flattened exhibiting a rectangular cross-sectional shape. A first aperture 26 extends through first end 22. A second aperture 28 extends through second end 24.

Inner sleeve 12 is a metal tube having a generally circular cylindrical shape. Inner sleeve 12 includes an inner surface 32 having a substantially right cylindrical shape defining a through bore extending from a first end face 34 of inner sleeve 12 to a second end face 36 of inner sleeve 12. First end face 34 is positioned at a first end 38 of inner sleeve 12, while second end face 36 is positioned at a second end 40 of inner sleeve 12.

An outer surface 44 of inner sleeve 12 has a slightly more complex contour than inner surface 32. For instance, a body portion 46 of inner sleeve 12 includes a bulbous cross-sectional shape. In the example depicted in the figures, outer surface 44 includes a central portion 48 exhibiting a substantially cylindrical shape. On either side of body portion 46 exists a cylindrical first neck portion 52 and a cylindrical second neck portion 54. In the non-limiting example depicted in the figures, first neck portion 52 and second neck portion 54 are cylindrically shaped having the same outer diameter. The outer diameter of first neck portion 52 and second neck portion 54 are less than the outer diameter of central portion 48. A first sloped surface 58 interconnects central portion 48 of outer surface 44 with first neck portion 52. First sloped surface 58 may be substantially conically shaped or may be a blend of two or more radii to obtain a smooth transition from the cylindrical surface at central portion 48 to the cylindrical surface at first neck portion 52. Similarly, a second sloped surface 62 circumferentially extends about inner sleeve 12 and interconnects central portion 48 with second neck portion 54. Second sloped surface 62 is substantially the mirror image of the first sloped surface 58.

A radially outwardly extending first flange 64 is positioned at first end 38. A radially outwardly extending second flange 68 is positioned at second end 40. First flange 64 is delimited by first end face 34 and a circumferentially extending first cylindrical surface 66. Second flange 68 is delimited by second end face 36 and a circumferentially extending second cylindrical surface 69. First flange 64 and second flange 68 exhibit substantially the same outer diameter having a magnitude less than the outer diameter of central portion 48 but greater than the outer diameters of first neck portion 52 and second neck portion 54.

A third sloped surface 70 provides a transition from first flange 64 to first neck portion 52. Third sloped surface 70 circumferentially extends about inner sleeve 12 and may be conically shaped or include two or more radii blended together. A fourth sloped surface 74 circumferentially extends about inner sleeve 12 as yet another portion of outer surface 44. Fourth sloped surface may be conically shaped or configured as a blend of radii in the same manner as third sloped surface 70. It should be appreciated that any one or more of the first through fourth sloped surfaces, or more generically first through fourth surfaces 58, 62, 70, 74, may be a surface extending substantially perpendicularly to a longitudinal axis of inner sleeve 12.

In a method of manufacturing elastomeric bushing assembly 10, inner sleeve 12 and outer sleeve 14 and placed in an injection molding machine. Elastomeric bumper 16 is injected within the annular space between inner surface 96 of outer sleeve 14 and outer surface 44 of inner sleeve 12 to bond elastomeric bumper 16 thereto. Elastomeric bumper 16 may be constructed from any suitable elastomer including natural rubber, EDPM, or the like. During solidification of the elastomer after injection molding, tensile stresses may be present in elastomeric bumper 16. To improve life expectancy of elastomeric bushing assembly 10, a swaging process is executed to reduce the outer diameter and the inner diameter of outer sleeve 14. The swaging process places elastomeric bumper 16 in compression such that inner surface 96 of outer sleeve 14 drives elastomeric bumper 16 toward each of the first, second, third and fourth sloped surfaces 58, 62, 70, 74, respectively

In an alternate method, elastomeric bumper 16 is only bonded to outer surface 44 of inner sleeve 12. In an asmolded, unloaded free state condition, elastomeric bumper 16 includes an outer cylindrical surface 80 having an outer diameter greater than an inner diameter defined by outer sleeve. Elastomeric bumper 16 is place in compressed state once inner sleeve 12 and elastomeric bumper 16 are press-fit into outer sleeve 14.

Elastomeric bumper 16 includes a central portion 84 having a reduced wall thickness and a substantially hollow cylindrical shape. Elastomeric bumper 16 also includes a first cushion portion 86 molded in engagement with first sloped surface 58, first neck portion 52 and third sloped surface 70 of inner sleeve 12. Elastomeric bumper 16 also includes a second cushion portion 90 axially spaced apart from first cushion portion 86 and on the opposite side of central portion 84 as first cushion portion 86. Second cushion portion 90 is molded in engagement with second sloped surface 62, second neck portion 54 and fourth sloped surface 74. Elastomeric bumper 16 may optionally axially extend over and into contact with first cylindrical surface 66 and second cylindrical surface 69 of first flange 64 and second flange 68, respectively.

Outer sleeve 14 is a substantially right circular cylindrical hollow member made of metal. Outer sleeve 14 includes a cylindrical inner surface 96 and a cylindrical outer surface 98. Outer sleeve 14 further includes a first end surface 102 and an opposite second end surface 104. Outer sleeve 14 includes a length equal to a distance between first end surface 102 and second end surface 104. The length of outer sleeve 14 is less than a length of inner sleeve 12 which is considered to be the distance between first end face 34 and second end face 36 of inner sleeve 12. It is envisioned that elastomeric bumper 16 and outer sleeve 14 are positioned at an axially centered location on inner sleeve 12 when viewed in axial cross section. A radial innermost surface 110 of elastomeric bumper 16 extends an axial length at least encompassing third sloped surface 70 and fourth sloped surface 74 and may further extend to encapsulate cylindrical surfaces 66 and 69. The length of outer sleeve 14 is sufficient to circumscribe central portion 48 and each of first neck portion 52 and second neck portion 54. The outer sleeve may encompass at least portions of third sloped surface 70 and fourth sloped surface 74. Optionally, a first annular recess 114 may be provided at a first end 116 of elastomeric bumper 16. An optional second annular recess 118 may be provided at a second end 120 or elastomeric bumper 16.

The provision of third sloped surface 70 and first flange 64 provide a geometric constraint or confinement of first cushion 86 of elastomeric bumper 16. External forces attempting to axially translate outer sleeve 14 relative to inner sleeve 12 will be resisted by first cushion 86 being driven into engagement with either third sloped surface 70 or first sloped surface 58. Second cushion 90 functions similarly to restrict relative axial movement between inner sleeve 12 and outer sleeve 14 based on the provision of second cushion 90, second sloped surface 62 and fourth sloped surface 74. Relative conical movement between inner sleeve 12 and outer sleeve 14 is also restricted by the same geometrical conditions. The arrangement of first cushion 86, second cushion 90, first sloped surface 58, second sloped 62, third sloped surface 70 and fourth sloped 74 also contribute to increasing the radial rate of force per unit of radial displacement of outer sleeve 14 relative to inner sleeve 12. The first and second cushions 86, 90 were previously placed in compression using the swaging or inserting processes earlier described. Loads attempting to move inner sleeve 12 relative to outer sleeve 14 while the cushions are in compression are resisted based on the elastomer's compressive stiffness.

It should be appreciated that outer sleeve 14 maintains its original substantially right circular cylindrical shape before and after the assembly process of circumscribing elastomeric bumper 16. Subsequent processes of prior art assembly methods are not required. Specifically, a method of manufacturing the elastomeric bushing assembly of the present disclosure does not include radially inwardly crimping or curling the ends of outer sleeve 14. Re-swaging or grinding of external surface 98 is not required because outer sleeve 14 is not undesirably deformed during an end curling process.

Modifications and variations of the present disclosure are possible in light of the above teachings and may be practiced otherwise than as specifically described while within the scope of the appended claims.

What is claimed is:

1. An elastomeric bushing comprising:
an inner sleeve;
an elastomeric bumper disposed around and directly engaging the inner sleeve; and
an outer sleeve disposed around the inner sleeve and the elastomeric bumper, the outer sleeve being spaced apart from the inner sleeve and directly engaging the elastomeric bumper, wherein the inner sleeve includes a radially outwardly extending first flange at a first end and a radially outwardly extending second flange axially spaced apart from the first flange and positioned at an opposite second end, the inner sleeve including a centralized bulbous portion as well as first and second neck portions positioned on opposite sides the centralized bulbous portion, the inner sleeve further including a first sloped surface extending between the centralized bulbous portion and the first neck portion, a second sloped surface extending between the centralized bulbous portion and the second neck portion, a third sloped surface extending between the first flange and the first neck portion, and a fourth sloped surface extending between second flange and the second neck portion,
the outer sleeve including a cylindrical inner surface,
the first sloped surface and the third sloped surface trapping a first cushion portion of the elastomeric bumper therebetween, the second sloped surface and the fourth sloped surface trapping a second cushion portion of the elastomeric bumper therebetween.

2. The elastomeric bushing according to claim 1, wherein the inner sleeve is hollow cylindrically-shaped one-piece monolithic component including the first, second, third, and fourth sloped surfaces.

3. The elastomeric bushing according to claim 1, wherein the first and second cushion portions have the same cross-sectional shape.

4. The elastomeric bushing according to claim 1, wherein the elastomeric bumper is bonded to the inner sleeve.

5. The elastomeric bushing according to claim 1, wherein the elastomeric bumper is bonded to the inner sleeve and the outer sleeve.

6. The elastomeric bushing according to claim 1, wherein the inner sleeve is coaxially aligned with the outer sleeve.

7. The elastomeric bushing according to claim 1, wherein the first sloped surface is opposed to the third sloped surface.

8. The elastomeric bushing according to claim 7, wherein the second sloped surface is opposed to the fourth sloped surface.

9. The elastomeric bushing according to claim 1, wherein the inner sleeve axially extends beyond the outer sleeve at each end of the outer sleeve.

10. The elastomeric bushing according to claim 1, wherein opposite ends of the outer sleeve are not inwardly deformed.

11. The elastomeric bushing according to claim 1, wherein the outer sleeve includes a cylindrical inner surface and a cylindrical outer surface.

12. The elastomeric bushing according to claim 1, wherein a load attempting to axially move the outer sleeve relative to the inner sleeve increases based on the elastomeric compressive properties of the first and second cushion portions of the elastomeric bumper.

13. An elastomeric bushing comprising:
an inner sleeve;
an elastomeric bumper disposed around and directly engaging the inner sleeve; and
an outer sleeve disposed around and directly engaging the elastomeric bumper, wherein the inner sleeve includes a centralized bulbous portion as well as first and second neck portions positioned on opposite sides of the centralized bulbous portion, the inner sleeve further including a radially outwardly extending first surface positioned between the centralized bulbous portion and the first neck portion, a radially outwardly extending second surface positioned between the centralized bulbous portion and the second neck portion, a radially outwardly extending third surface positioned at the opposite end of the first neck portion as the first surface, and a radially outwardly extending fourth surface positioned at the opposite end of the second neck portion as the second surface,
the first surface and the third surface trapping a first cushion portion of the elastomeric bumper therebetween, the second surface and the fourth surface trapping a second cushion portion of the elastomeric bumper therebetween.

14. The elastomeric bushing according to claim 13, wherein the inner sleeve is hollow cylindrically-shaped one-piece monolithic component including the first, second, third, and fourth surfaces.

15. The elastomeric bushing according to claim 13, wherein the elastomeric bumper is bonded to the inner sleeve and the outer sleeve.

16. The elastomeric bushing according to claim 13, wherein the inner sleeve axially extends beyond the outer sleeve at each end of the outer sleeve.

17. The elastomeric bushing according to claim 13, wherein the outer sleeve includes a cylindrical inner surface and a cylindrical outer surface.

18. The elastomeric bushing according to claim 13, wherein the inner sleeve is coaxially aligned with the outer sleeve.

19. The elastomeric bushing according to claim 13, wherein the first and second cushion portions have the same cross-sectional shape.

20. An assembly comprising:
a bar pin and the elastomeric bushing of claim 13, wherein the bar pin is at least partially positioned within the inner sleeve.
